(19) United States
(12) Patent Application Publication
(10) Pub. No.: US 2005/0206950 A1
(43) Pub. Date: Sep. 22, 2005

(54) Printing system and its display control method, image forming apparatus and its control method, and program

(75) Inventors: Takahiro Ushiro, Ibaraki-ken (JP); Norifumi Miyake, Chiba-ken (JP); Ikuo Takeuchi, Ibaraki-ken (JP); Toshihiko Kitahara, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/080,395

(22) Filed: Mar. 16, 2005

(30) Foreign Application Priority Data
Mar. 19, 2004 (JP) 2004-080985

(51) Int. Cl. G06F 15/00

(52) U.S. Cl. 358/1.15

(57) ABSTRACT

A printing system for processing a print job transmitted from a terminal to a printer by the printer, includes a display which can display information associated with the print job, and a controller which switches in accordance with a demanding party of the information associated with the print job whether all pieces of information associated with the print job are displayed on the display or some pieces of information associated with the print job are limited upon display on the display.

### FIELD OF THE INVENTION

The present invention relates to a printing system which executes a print job generated by a terminal using an output apparatus such as a copying machine, printer, or the like and, more particularly, to a printing system which can display a list of information associated with jobs on a terminal or printer.

### BACKGROUND OF THE INVENTION

In a conventional image forming system, a printer is often shared by a plurality of terminals. In such system, a plurality of personal computers send print jobs to a single printer via a network such as a LAN, Internet, or the like. The printer stores these print jobs, and processes them in turn. At this time, when a personal computer connected to the network including those which issued print jobs sends a print job list inquiry to the printer, the printer returns a print job list as information associated with print jobs in response to this inquiry. Upon reception of the print job list response, the personal computer can display the print job list on its display unit.

The print job list includes a document name, an issuer (owner) name, processing status of a print job, the number of pages of a document, a document size, reception time, and the like. The processing status of a print job includes, e.g., the processing states of a job such as print wait, print in progress, error, and the like. The issuer name is the name of a personal computer, user, or the like that issued the print job. A person who wants to issue a print job can determine with reference to the information included in this print job list how to efficiently execute that print job.

For example, according to the invention disclosed in Japanese Patent Laid-Open No. 2001-205863, when printers are equipped in a work site, home, and the like, and printer users are known, a person who wants to use a printer can refer to the job status of others by displaying a job list. Hence, the person who wants to use a printer can use a ready printer when a plurality of printers are available, or can directly give caution to another person who inappropriately uses a printer.

Thus, when users are specified in the work site, home, and the like, the job list can be displayed unconditionally. However, in case of a highly public printer which is connected to the Internet and is used to print by general public, it is a problem to allow unspecified users to unconditionally browse a job list of that printer in terms of protection of personal information.

For example, a convenience store, print shop, and the like offer services that provide printers via the Internet. In such services, in order to protect client's information from being browsed by a third party, print job information other than that of a client himself or herself is inhibited from being browsed. Since display of a job list is limited, client's personal information is prevented from being browsed by unspecified users. However, it becomes impossible for a client, i.e., a person who wants to print, to investigate the job states of others with reference to the job list and to take an appropriate action according to the states.

In this way, when the job list that can be referred to by printer users is limited, personal information can be protected, but the user cannot recognize the use state of the printer. On the other hand, when the job list is released to the public, personal information is also released to the public together with the job list.

### SUMMARY OF THE INVENTION

The present invention has been made in consideration of the prior art, and has as its object to provide a printing system and display control method, and an image forming apparatus and its control method, which can provide information associated with the use state of a printer while protecting personal information.

In order to achieve the above object, the present invention is characterized by the following arrangement.

A printing system for processing a print job transmitted from a terminal to a printer by the printer, comprises:
a display which can display information associated with the print job; and
a controller which switches in accordance with a demanding party of the information associated with the print job whether all pieces of information associated with the print job are displayed on the display or some pieces of information associated with the print job are limited upon display on the display.

The present invention is characterized by the following arrangement.

An image forming apparatus for processing a print job received from a terminal, comprises:
a display which can display information associated with the print job; and
a controller which switches in accordance with a demanding party of the information associated with the print job whether all pieces of information associated with the print job are displayed on the display or some pieces of information associated with the print job are limited upon display on the display.

The present invention is characterized by the following arrangement.

An image forming apparatus for processing a print job received from a terminal, comprises:
a communication device which transmits information to the terminal; and
a transmission device which switches in accordance with a request from the terminal whether all pieces of information associated with the print job are transmitted or some pieces of information associated with the print job are limited upon transmission.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a network connection diagram showing the overall system;

FIG. 2 is a block diagram showing the hardware arrangement of a computer 2, 3, or 4;

FIG. 3 is a block diagram showing the hardware arrangement of a copying machine 1;

FIG. 4 is a block diagram showing the processing blocks of the computer 3 or 4 and the copying machine 1, which are connected to the Internet;

FIG. 5 shows the contents displayed on a local window on a display 3-203 of the computer 3;

FIG. 6 shows the contents displayed on a local window on a display 4-203 of the computer 4;

FIG. 7 shows the contents displayed on a local window on a display 2-203 of the computer 2;

FIG. 8 shows a print job information list;

FIG. 9 is a flowchart showing the main processing flow of the copying machine 1;

FIG. 10 is a flowchart showing the detailed flow of job response step S104;

FIG. 11 is a flowchart showing the detailed flow of job display step S105;

FIG. 12 is a flowchart showing the detailed flow of inquiry response step S107;

FIG. 13 is a flowchart showing the main flow of a printer driver of the computer 2, 3, or 4;

FIG. 14 is a flowchart showing the detailed flow of job transmission (step S402); and

FIG. 15 is a flowchart showing the detailed flow of job monitor (step S403).

### DESCRIPTION OF THE PREFERRED EMBODIMENTS

<System Arrangement>

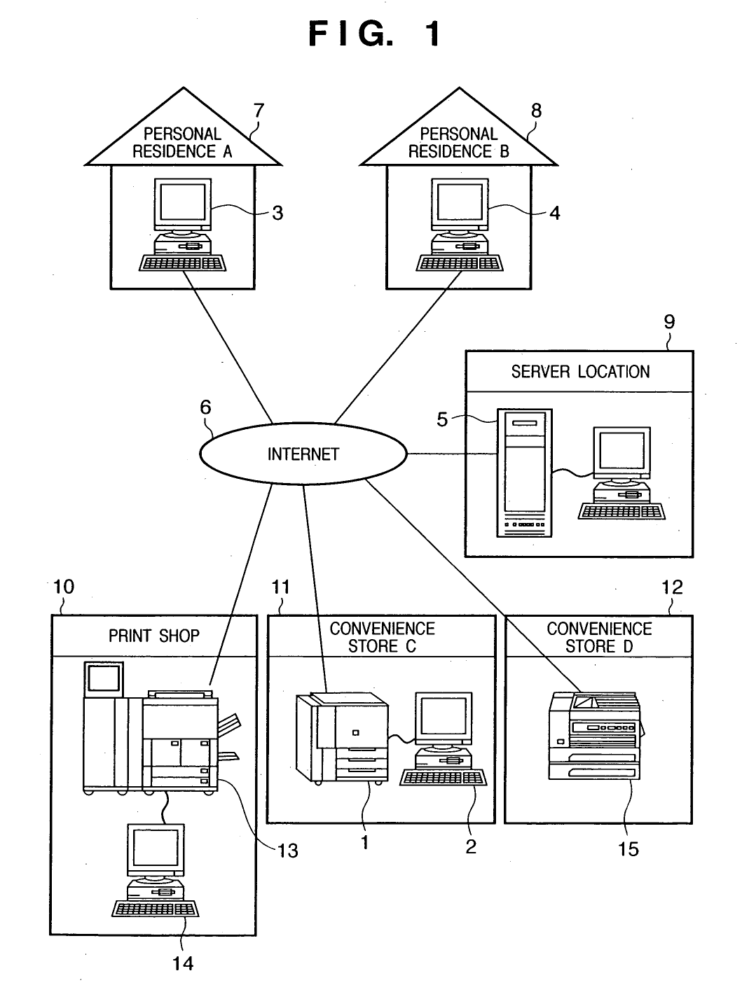

FIG. 1 is a network connection diagram showing the overall system of the present invention. In FIG. 1, a plurality of copying machines (1, 13, 15) and a plurality of computers (2, 3, 4, 5, 14) are connected to the Internet. Also, the copying machines or computers or both of them are arranged for respective locations (7, 8, 9, 10, 11, 12). In FIG. 1, a computer 3 is equipped in a personal residence 7, a computer 4 is equipped in a personal residence 8, a computer 5 is equipped in a server location 9, a computer 14 and copying machine 13 are equipped in a print shop 10, a computer 2 and copying machine 1 are equipped in a convenience store 11, and a copying machine 15 is equipped in a convenience store 12.

The user can print a document or image from the computer 3 or 4 equipped in the personal residence 7 or 8 using the copying machine 1, 15, or 13 equipped in the convenience store 11 or 12 or print shop 10. This print request can be issued in the same manner as a case wherein a printing process is executed by a printer directly connected to a computer. Prior to issuance of a print job, a process for authenticating the user by the server computer 5 or the like and charging an amount for the user ID or the like can be executed together. In either case, when the user issues a print instruction, a print job is issued, and is passed from the computer to the copying machine via the Internet.

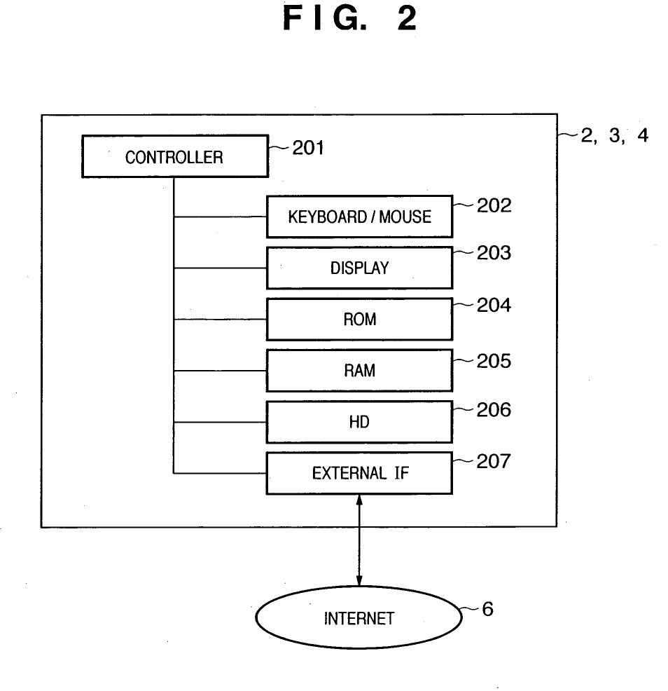

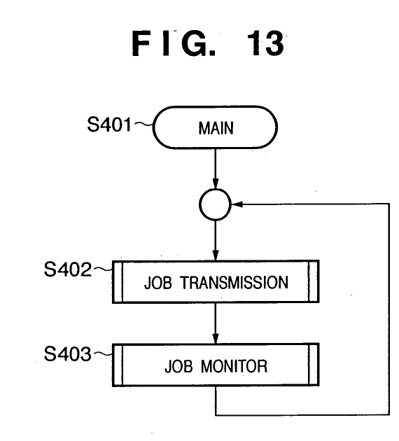

FIG. 2 shows the hardware arrangement of the computer 2, 3, or 4. The computer comprises a controller 201 including a CPU, a keyboard/mouse 202 used by the user to input instructions, a display 203 for displaying images such as a job list and the like, a ROM 204, RAM 205, and HD 206 as media for storing programs and data, and an external IF 207 used to communicate with the Internet or the like and an external device. The computer is connected to the internet 6 via the external IF 207. The controller 201 can implement the sequences shown in FIGS. 13 to 15 by executing predetermined programs.

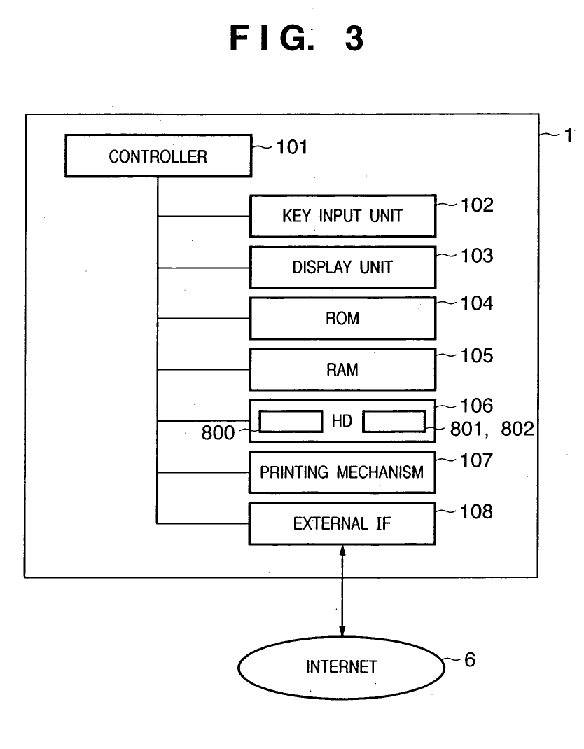

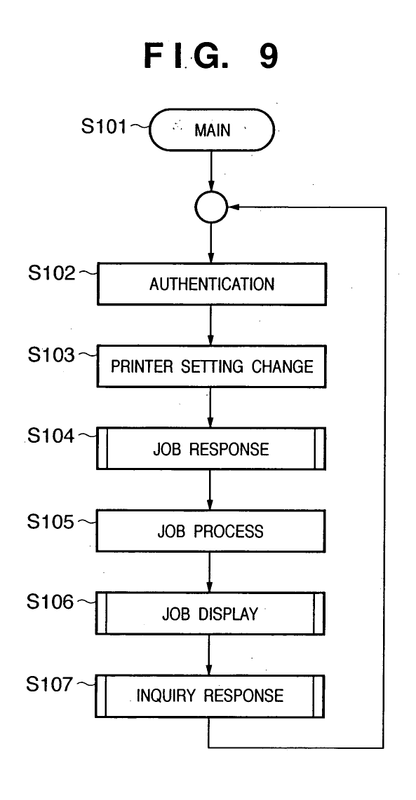

FIG. 3 shows the hardware arrangement of the copying machine 1. The copying machine 1 comprises a controller 101 including a CPU, a key input unit 102 used by the user to input instructions, a display 103 for displaying images such as a job list and the like, a ROM 104, RAM 105, and HD 106 as storage media, a printing mechanism 107 for forming an image on a printing medium, and an external IF 108 used to communicate with the Internet and an external apparatus such as a host computer or the like. The copying machine is connected to the internet 6 via the external IF 108. The controller 101 can implement the sequences shown in FIGS. 9 to 12 by executing predetermined programs.

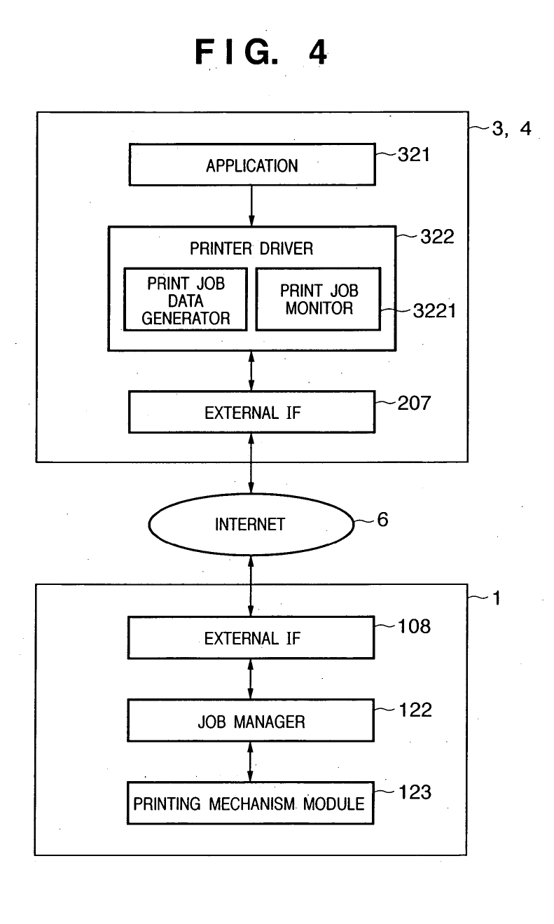

FIG. 4 is a block diagram showing the processing blocks of the computer 3 or 4 and the copying machine 1, which are connected to the Internet. The processing blocks shown in FIG. 4 are software modules which are implemented by executing predetermined programs by the controllers shown in FIGS. 2 and 3 except for the external IFs.

In the computer 3 or 4 in FIG. 4, an application 321 includes a document processing application such as a text editor or the like, and an image processing application such as a paint brush or the like. These applications pass data to be printed to a printer driver 322. The printer driver 322 generates a print job by converting the passed data into print data and print commands in a predetermined format, and can output that print job to the external copying machine or printer via the external IF 207.

A print job monitor 3221 of the printer driver 322 can send an inquiry about the job status to the external copying machine or printer via the external IF 207, and can display its information (job list). The job list may be displayed necessarily after the print job is issued or in response to a user's request.

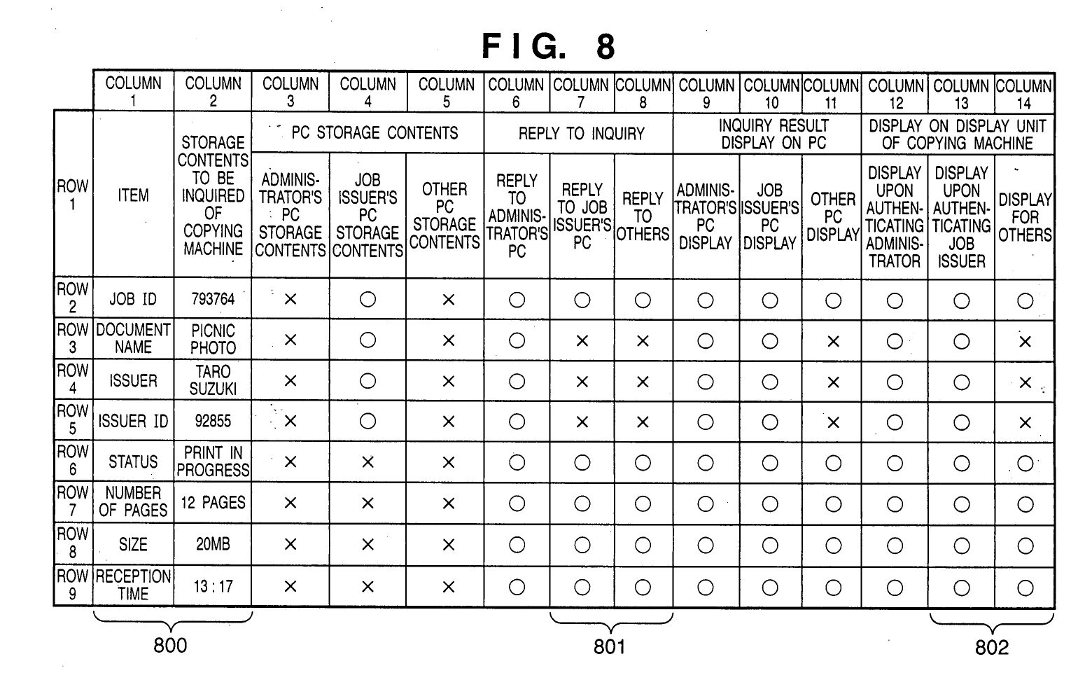

On the other hand, in the copying machine 1, upon reception of the print job from the computer 3 or 4 via the external IF 108, a job manager 122 stores and processes that print job in the hard disk 106 or the like, and a printing mechanism module 123 prints that job. The received print job is enqueued in a print queue in principle, and is processed and printed in the order of arrival. Upon reception of the inquiry about a print job via the external IF 108, the copying machine 1 transmits information of a print job stored in the job manager as a response. If a plurality of pieces of information associated with a plurality of print jobs are stored, all these pieces of information are transmitted. As will be described later with reference to FIG. 8, information to be transmitted is changed in accordance with the computer or user as the inquiry source.

<Job Status Display>

Assume that the computer 3 in FIG. 1 issues a print job required to print a document “picnic photo” to the copying machine 1, and the computer 4 issues a print job required to print a document “swimming photo” to it.

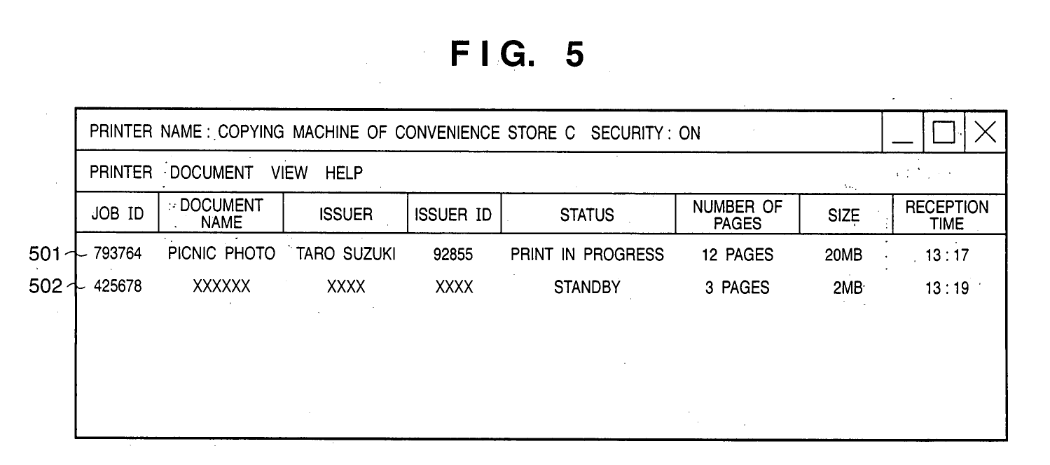

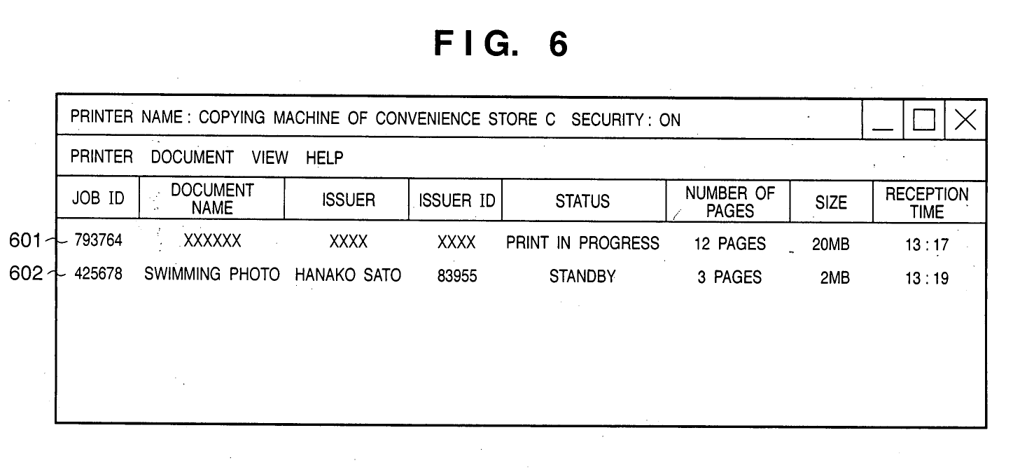

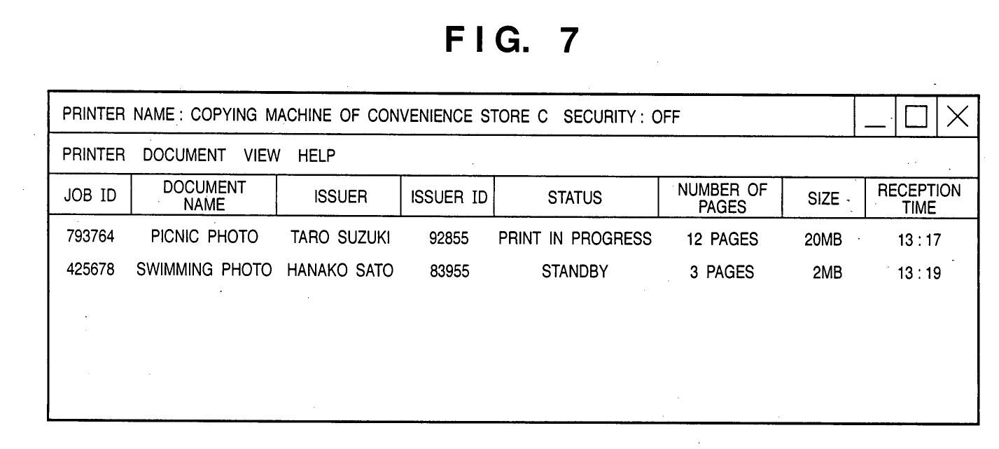

FIG. 5 shows an example of a status window of print jobs of the copying machine 1, which is displayed on the display 203 (to be referred to as the display 3-203 hereinafter; the same applies to the remaining computers) of the computer 3 in this case. FIG. 6 shows an example of a status window of print jobs of the copying machine 1, which is displayed on the display 4-203 of the computer 4. FIG. 7 shows an example of a status window of print jobs of the copying machine 1, which is displayed on the display 2-203 of the computer 2. Such status window is consequently displayed when the printer driver of each computer transmits an inquiry about print jobs to the copying machine 1, and the copying machine 1 replies to it.

FIGS. 5, 6, and 7 include different parts hidden by “XXX” in their job lists. That is, in FIG. 5 all items are displayed in a job display column 501 with a job ID=793764, but the items of a document name, issuer, and issuer ID are hidden and are not, in effect, displayed in a job display column 502 with a job ID=425678. In FIG. 6, all items are displayed in a job display column 601 with a job ID=425678, but the items of a document name, issuer, and issuer ID are hidden and are not, in effect, displayed in a job display column 602 with a job ID=793764. In FIG. 7, no items are hidden, and all items are displayed for all jobs. Note that the same job list as in FIG. 5, 6, or 7 can also be displayed on the display unit of the copying machine 1.

As can be seen from FIG. 5, the printer name is “copying machine of convenience store C”, two job IDs are displayed, and the copying machine 1 is currently processing two print jobs. Jobs high up on the job list are those which are received earlier. The job with the job ID=793764 is a print job issued by the computer 3 on which the job list of FIG. 5 is displayed, and its document name, issuer, and issuer ID are displayed. In addition, processing status, the number of pages, a file size, a print job reception time, and an elapsed time are displayed.

On the other hand, the job with the job ID=425678 is a print job which is issued not by the computer 3 on which the job list of FIG. 5 is displayed but by the computer 2, and the document name, issuer, and issuer ID are hidden. However, other kinds of information, i.e., processing status, the number of pages, a file size, a print job reception time, and an elapsed time are displayed.

In this way, as for a job issued by the self computer, the job list including the document name, issuer, and issuer ID as private information (personal information) is displayed. Hence, the user can browse such information. However, as for a job issued by another user, the user cannot browse private information of that job since it is hidden on the job list.

In FIG. 6, since the relationship between the computer that displays the job list, and the source computers of the print jobs is replaced from that in FIG. 5, the display contents change accordingly. However, as in FIG. 5, as for a job issued by the self computer, the job list including the document name, issuer, and issuer ID as private information (personal information) is displayed. As for a job issued by another user, private information is hidden on the job list.

FIG. 7 shows an example of display on the computer 2 equipped in the convenience store 11 where the copying machine 1 is equipped. Since the computer 2 is that of the administrator of the copying machine 1, the job list has no hidden parts, and displays all pieces of information.

<Control Table>

FIG. 8 is a table showing correspondence between items indicating the status of the print job, and the storage and display contents of its information. In FIG. 8, column 1 shows items of print job information stored in the printer. Column 2 indicates a practical example of the contents stored in the printer for respective items. Columns 3 to 5 indicate the stored information (items) (O) and non-stored information (items) (X) of respective computers upon issuance of the print job. For example, the personal computer (PC) of the administrator (column 3) and the personal computer of a third party (other) (column 5) have no information about the print job since they are uninvolved in issuance of the print job. The personal computer of the job issuance source (column 4) has information of items such as the job ID, document name, issuer, and issuer ID, but has no information about items (e.g., status, the number of pages, a size, and reception time) given by the copying machine that processes the print job.

Columns 6 to 8 indicate items to be replied (O) and those not to be replied (X) by the printer in response inquiries of respective computers. Columns 9 to 11 indicate items to be displayed (O) and those to be hidden (X) for respective computers. Columns 12 to 14 show items to be displayed (O) and those to be hidden (X) by authentication upon displaying the print job list on the display unit 1-103 of the printer. Note that rows 2 to 9 are included in the job list associated with one print job. As for columns 2 to 5, the same kinds of information are stored in correspondence with the number of print jobs which are currently being processed.

Note that as for columns 6 to 8 and 12 to 14 in FIG. 8, items to be replied and displayed fixedly according to the contents of the table may be determined. Alternatively, the contents of these columns may be stored as a table in the hard disk 106 of the copying machine, and may be referred to upon reply or display in response to an inquiry about job status so as to determine items to be replied and displayed. In this way, items to be hidden can be changed, and the display contents can be flexibly changed. In this embodiment, the contents of columns 7 and 8 are saved as a reply control table 801 and the contents of columns 13 and 14 are saved as a display control table 802 in the hard disk 106 of the copying machine. As for the administrator's PC in columns 6 and 12, all items are to be replied or displayed, and these columns may also be included in the tables. Furthermore, column 2 of FIG. 8 is saved as print job information 800 in the hard disk or the like of the copying machine 1 until the print job is complete.

<Processing Sequence in Copying Machine>

FIG. 9 shows the main processing flow of the copying machine 1. Steps S102 to S107 are time-divisionally processed at high speed as if they were processed parallelly. However, respective steps can be considered as independent processes which are asynchronously executed in practice.

In FIG. 9, step S102 authenticates the access right to the copying machine. For example, it is checked based on the computer ID or user ID included in inquiry information if the computer that issued a job status inquiry is the administrator's computer 2, a computer which is not the administrator's computer but has the right of inquiry, or a computer having no right, thus authenticating the access right. The same applies to a case wherein a print job is input. When the job list is displayed on the display unit of the copying machine, that display request is input from the console of the copying machine itself. In this case, whether a person who is making that key operation is the administrator or a person with which user ID is determined on the basis of the ID information of the user input prior to the request, thus authenticating the user.

Step S103 is a printer setting (copy machine setting) change step that accepts various setting changes, which include a security ON/OFF setting. The security setting can be changed only when the user is authenticated as the administrator, and cannot be changed by users other than the administrator. If the reply control table 801 and display control table 802 are programmable, and their settings are allowed (settings of items to be replied/not to be replied, and setting of items to be displayed/not to be displayed), changes of these tables are desirably given as the right unique to the administrator as in security. Settings of security, tables, and the like are stored in the hard disk 106, a programmable ROM, or the like of the copying machine.

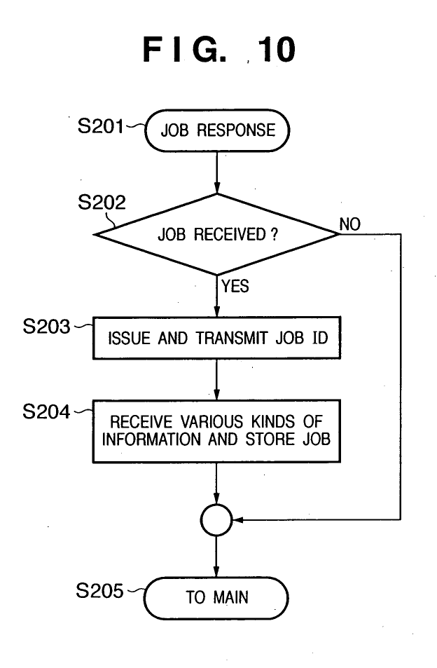

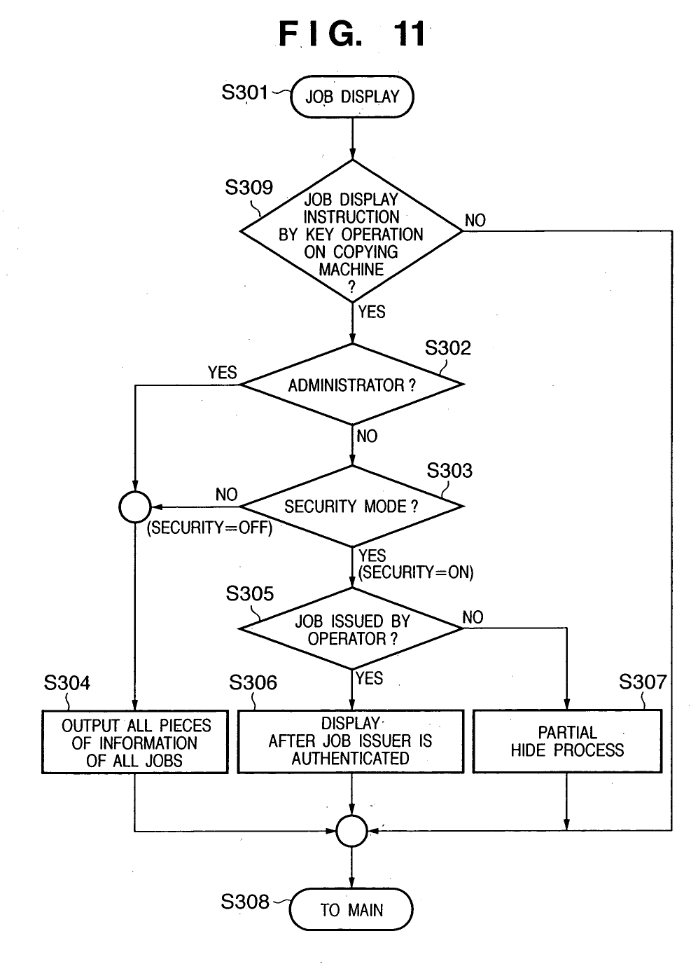

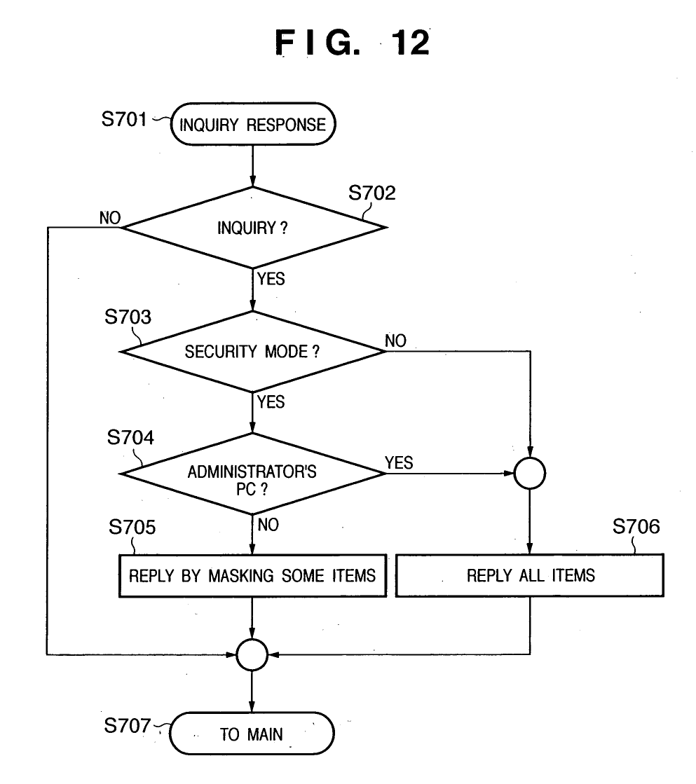

Step S104 is a job response step, which receives a print job from the computer 2, 3, 4, or the like and returns a reply. Details of this process will be explained later using the flow of FIG. 10. Step S105 is a job process step, which executes a print process of the received print job. Step S106 is a job display step, which displays a list of print jobs whose processes are underway on the display unit 1-103 of the copying machine 1. Details of this process will be explained later using the flow of FIG. 11. In step S107, job list information of print jobs is returned in response to an inquiry from the computer 2, 3, or 4. Details of this process will be explained later using the flow of FIG. 12.

FIG. 10 shows the detailed flow of the job response step (step S104). Upon reception of a job from any of the computers 2, 3, and 4 (step S202), a job ID is assigned to the received print job, and the assigned job ID is transmitted to that computer (step S203). Various kinds of information (print job information) of the print job are received, and are stored as a print job information file on a predetermined storage area, i.e., on the hard disk (step S204). The print job information includes the document name, issuer name, issuer ID, number of pages, and size or data that can specify the size. Also, the reception time of the print job is read from a clock, and is stored as a part of the print job information. In this manner, the print job information 800 shown in FIG. 8 associated with the received print job is saved in the copying machine.

FIG. 11 shows the detailed flow of the job display step (step S105). Upon reception of a job display instruction from the key input unit of the copying machine (step S309), it is checked based on the information (user's ID information) authenticated in step S102 in FIG. 9 if the person who issued the instruction is the administrator (step S302). If the person who issued the instruction is the administrator, all pieces of information of all jobs are displayed on the display unit of the copying machine (step S304). That is, items (O) are displayed on the display unit of the copying machine, as indicated by column 12 of FIG. 8. The job list is displayed on the display unit of the copying machine in the format shown in, e.g., FIG. 7.

On the other hand, if it is determined in step S302 that the person who issued the instruction is not the administrator, it is checked whether a security mode is ON or OFF (step S303). If the security mode is OFF, all pieces of information of all jobs are also displayed on the display unit of the copying machine (step S304). In this case as well, the job list is displayed, as shown in FIG. 7. If the security mode is ON, steps S305 to S307 are executed for each print job. That is, steps S305 to S307 are repeated in correspondence with the number of print jobs held by the copying machine. For example, the first print job in the print job queue is set as a print job of interest. It is then checked if the print job of interest is that which was issued by the operator who is now operating the keys of the copying machine (step S305). For example, the user ID input upon authentication is compared with the issuer ID included in the print job information, and if the two IDs match, it is determined that the print job of interest is that which was issued by the operator. If it is determined that the print job of interest is that which was issued by the operator, information including private information is displayed on the display unit of the copying machine. That is, items (O) are displayed on the display unit of the copying machine, as indicated by column 13 of FIG. 8 (step S306). If it is determined that the print job of interest is not the one that was issued by the operator, information is partially displayed, and private information is hidden. That is, items (O) are displayed on the display unit of the copying machine, as indicated by column 14 of FIG. 8 (step S307). In this case, the display window is displayed in the format of FIG. 5 or 6. Upon completion of display of one print job, the next print job is selected as the print job of interest, and the process is repeated from step S305.

If the display control table 802 is programmable, items designated for the job issuer are displayed with reference to column 13 of the table 802 in step S306, and items designated for the user who is neither the job issuer nor the administrator are displayed with reference to column 14 of the table 802 in step S307.

Since it is checked in step S309 whether or not the job display instruction is input from the key input unit of the copying machine, no job list is displayed on the displayed unit of the copying machine in response to an inquiry from the computer.

FIG. 12 shows the detailed flow of the inquiry response step (step S107). It is checked if an inquiry from some computer is detected (step S702). If no inquiry is detected, no process is made. If it is determined that an inquiry is detected, it is checked if the security mode is set (security=ON) (step S703). If the security mode is not set (security=OFF), all pieces of job information of all jobs are returned to the computer as an inquiry source (step S706). If the security mode is set, it is checked if the inquiry is input from the administrator's computer 2 (step S704). If the inquiry is input from the administrator's computer 2, all pieces of job information of all jobs are returned to the computer as an inquiry source, i.e., the computer 2. In this case, items (O) in column 6 of FIG. 8 are displayed (step S706).

If the inquiry is not the one from the administrator's computer, job information is partially masked, and is returned to the computer as an inquiry source. That is, items (O) in columns 7 and 8 in FIG. 8 are returned to the computer as an inquiry source (step S705). The process for displaying a reply will be described later using the flow of the printer driver of the computer.

If the reply control table 801 is programmable, column 7 of the table 801 is referred to for print job information of the print job which includes the issuer ID that matches the user ID of the inquiry source, and column 8 of the table 801 is referred to for print job information of other print jobs in step S705. Then, job information to be returned is generated to include items set to be “replied” (i.e., items (O)) and not to include other items, and is transmitted to the computer as an inquiry source.

<Processing of Computer>

FIG. 13 shows the main flow of the printer driver of the computer 2, 3, or 4. A job transmission process (step S402) for transmitting a print job, and a job monitor process (step S403) for sending an inquiry about print jobs to the printer and displaying a job list are executed. These processes are time-divisionally executed as if they were processed parallelly.

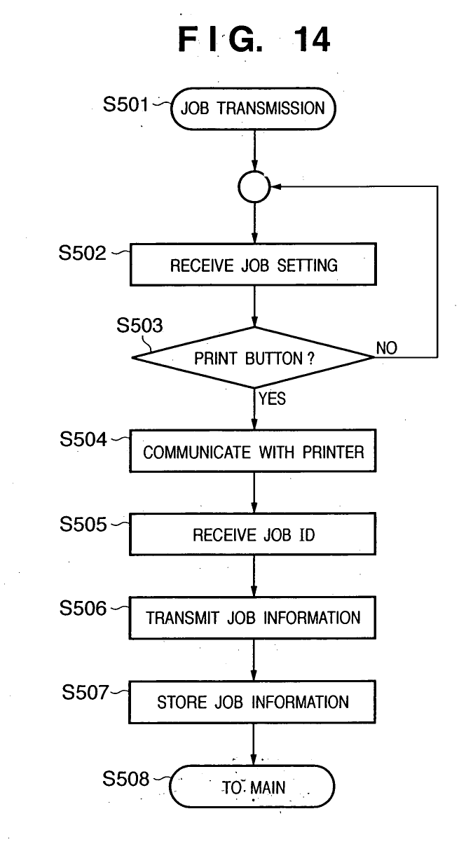

FIG. 14 shows the detailed flow of the job transmission process (step S402). The printer driver receives various settings of a job by the computer operator from an application such as a text editor or the like (step S502). If a print button is clicked (step S503), the printer driver communicates with the copying machine 1 (e.g., to transmit the print job to the copying machine 1) (step S504). Then, the printer driver receives the job ID which is issued by the copying machine 1 to that print job (step S505). This job ID is the number which is uniquely assigned to each job. After that, the printer driver transmits various kinds of print job information determined by the computer side (step S506). The various kinds of print job information to be transmitted include information required for a printing process, the document name, issuer name, issuer ID, number of pages, file size, and the like. These kinds of print job information, i.e., the document name, issuer name, and issuer ID are stored in a memory, hard disk, or the like in association with the job ID (step S507). In this case, items (O) in column 4 of FIG. 8 are stored.

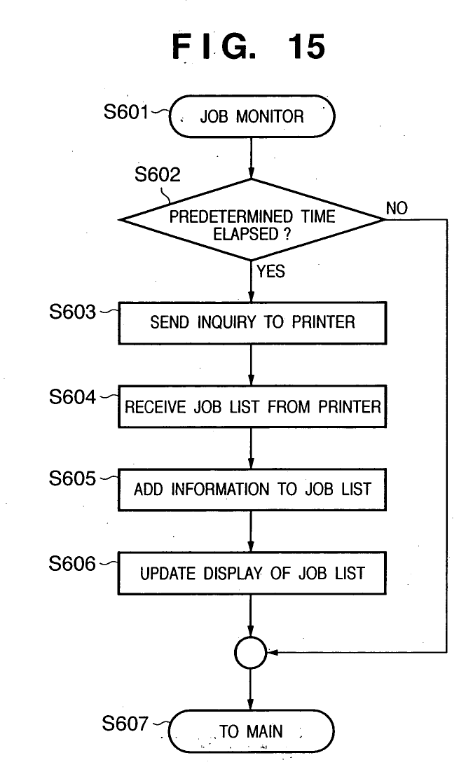

FIG. 15 shows the detailed flow of the job monitor process (step S403). The printer driver sends an inquiry about print job information of print jobs which are being processed by the copying machine 1 to the copying machine 1 (step S603) at predetermined time intervals (step S602). Note that this step S602 need not always be executed by the printer driver. For example, step S602 may be scheduled as a timer event generated after an elapse of a predetermined of time, and the sequence of FIG. 15 may be executed from step S603 at predetermined time intervals. In this case, the timer is reset in step S607.

The printer driver receives print job information from the copying machine 1 in response to the inquiry (step S604). At this time, the computer 2 used by the administrator and the remaining computers 3 and 4 receive different kinds of print job information. This is because the contents to be replied are different for each computer as an inquiry source, as has been explained using FIG. 12. Column 6 of FIG. 8 is received as a reply by the administrator's computer 2. Items (O) are received as information. Column 7 or 8 in FIG. 8 is a reply to be received by the computer 3 or 4. In this case, the computer receives the same reply independently of whether or not that computer issued the job. Note that the computer other than the administrator's computer often receives job information with contents depending on whether or not the computer is the issuance source of the print job which is being processed by the copying machine. Information to be received is determined by the setting contents of the reply control table 801.

In step S605, the printer driver generates a job list to be displayed on the basis of the print job information. In the example of FIG. 8, the computers other than that of the administrator do not receive the document name, issuer name, and issuer ID. However, as for the print job issued by the self computer, the printer driver adds information stored in step S507 in FIG. 14, i.e., the document name, issuer name, and issuer ID stored in association with the job ID, to the print job information received from the copying machine (step S605). Then, the printer driver displays a job list (step S606). That is, all pieces of print job information are displayed in the job list on the computer 2, as shown in FIG. 7. On the computers 3 and 4, the document name, issuer name, and issuer ID are not displayed or are displayed in an unknown state for the print job which was not issued by the self computer, as shown in FIGS. 6 and 7.

With the above arrangement, in the printing system of this embodiment, the display destination and transmission destination of personal information included in print job information can be limited to an owner of that information or the administrator. Information other than the personal information can be transmitted and displayed for a third party. For this reason, the user of the printing service can recognize the condition of the output apparatus (copying machine, printer, or the like) to be used as a job list even when the output apparatus is provided for public use. In addition, the personal information can be kept in secret except for its owner. Furthermore, items to be kept in secret for a third party can be defined.

In this embodiment, the security mode can be set ON/OFF on the market. However, the security mode=ON may be set for convenience stores and print shops upon delivery. Furthermore, in the above description, each printer has security settings. Alternatively, each printer driver stored in the computer may have settings, or each printer driver fixed with the security mode=ON may be distributed. Furthermore, if the ID is provided to the user, security ON/OFF settings may be provided to each ID.

In this embodiment, the computer connected to the Internet via a cable has been exemplified as a terminal that designates a print job. Alternatively, the computer may be connected to another network in place of the Internet. Also, the computer may be connected wirelessly in place of the cable. The terminal is not limited to a so-called computer such as a personal computer or the like, but a portable phone or portable terminal may be used. A document file to be printed may be the one stored in the terminal or may be the one stored at another location on the network. Furthermore, the print process may be done by the printer which is not a copying machine, or by a multi-function peripheral including a facsimile function and the like.

Note that the present invention may be applied to either a system constituted by a plurality of devices (e.g., a host computer, interface device, reader, printer, and the like), or an apparatus consisting of a single equipment (e.g., a copying machine, facsimile apparatus, or the like). The objects of the present invention are also achieved by supplying a storage medium (or recording medium), which records a program code of a software program that can implement the functions of the above-mentioned embodiments to the system or apparatus, and reading out and executing the program code stored in the storage medium by a computer (or a CPU or MPU) of the system or apparatus. In this case, the program code itself read out from the storage medium implements the functions of the above-mentioned embodiments, and the storage medium which stores the program code constitutes the present invention.

The functions of the above-mentioned embodiments may be implemented not only by executing the readout program code by the computer but also by some or all of actual processing operations executed by an operating system (OS) running on the computer on the basis of an instruction of the program code. Furthermore, the functions of the above-mentioned embodiments may be implemented by some or all of actual processing operations executed by a CPU or the like arranged in a function extension card or a function extension unit, which is inserted in or connected to the computer, after the program code read out from the storage medium is written in a memory of the extension card or unit.

As described above, according to this embodiment, information of a print job can be displayed in accordance with a demanding party of information associated with the print job. For this reason, the use condition of the printer can be provided to all users while protecting personal information of the users.

As many apparently widely different embodiments of the present invention can be made without departing from the spirit and scope thereof, it is to be understood that the invention is not limited to the specific embodiments thereof except as defined in the claims.

### CLAIM OF PRIORITY

This application claims priority from Japanese Patent Application No. 2004-080985 filed Mar. 19, 2004, which is hereby incorporated by reference herein.

1. A printing system for processing a print job transmitted from a terminal to a printer by the printer, comprising:
a display which can display information associated with the print job; and
a controller which switches in accordance with a demanding party of the information associated with the print job whether all pieces of information associated with the print job are displayed on said display or some pieces of information associated with the print job are limited upon display on said display.

2. The system according to claim 1, wherein when the demanding party is identical to an issuer of the print job, said controller controls said display to display all pieces of information associated with the print job.

3. The system according to claim 1, wherein when the demanding party is an administrator of said printing system, said controller controls said display to display all pieces of information associated with the print job.

4. The system according to claim 1, wherein when the demanding party is neither an issuer of the print job nor an administrator of said printing system, said controller controls not to display information associated with the issuer of the print job of the information associated with the print job.

5. The system according to claim 4, wherein information associated with an issuer of the print job includes at least one of a document name, issuer name, and issuer ID.

6. The system according to claim 1, wherein the printer has display control information which defines contents of information associated with the print job to be displayed depending on the demanding party, and
when the demanding party is neither an issuer of the print job nor an administrator of said printing system, said controller controls not to display information which is defined not to be displayed.

7. The system according to claim 1, wherein the printer comprises said display, and input means for inputting a request of information associated with the print job.

8. The system according to claim 1, wherein the terminal comprises said display, and input means for inputting a request of information associated with the print job.

9. An image forming apparatus for processing a print job received from a terminal, comprising:
a display which can display information associated with the print job; and
a controller which switches in accordance with a demanding party of the information associated with the print job whether all pieces of information associated with the print job are displayed on said display or some pieces of information associated with the print job are limited upon display on said display.

10. An image forming apparatus for processing a print job received from a terminal, comprising:
a communication device which transmits information to the terminal; and
a transmission device which switches in accordance with a request from the terminal whether all pieces of information associated with the print job are transmitted or some pieces of information associated with the print job are limited upon transmission.

11. A display control method for a printing system for processing a print job transmitted from a terminal to a printer by the printer, comprising:
a control step of switching in accordance with a demanding party of the information associated with the print job whether all pieces of information associated with the print job are displayed on a display or some pieces of information associated with the print job are limited upon display on the display.

12. The method according to claim 11, wherein the control step includes a step of controlling, when the demanding party is identical to an issuer of the print job, the display to display all pieces of information associated with the print job.

13. The method according to claim 11, wherein the control step includes a step of controlling, when the demanding party is an administrator of the printing system, the display to display all pieces of information associated with the print job.

14. The method according to claim 11, wherein the control step includes a step of controlling, when the demanding party is neither an issuer of the print job nor an administrator of the printing system, not to display information associated with the issuer of the print job of the information associated with the print job.

15. The method according to claim 14, wherein information associated with an issuer of the print job includes at least one of a document name, issuer name, and issuer ID.

16. The method according to claim 11, wherein the printer has display control information which defines contents of information associated with the print job to be displayed depending on the demanding party, and
the control step includes a step of controlling, when the demanding party is neither an issuer of the print job nor an administrator of the printing system, not to display information which is defined not to be displayed.

17. A method of controlling an image forming apparatus for processing a print job received from a terminal, comprising:
a control step of switching in accordance with a demanding party of the information associated with the print job whether all pieces of information associated with the print job are displayed on a display or some pieces of information associated with the print job are limited upon display on the display.

18. A method of controlling an image forming apparatus for processing a print job received from a terminal, comprising:
a transmission step of switching in accordance with a request from the terminal whether all pieces of information associated with the print job are transmitted or some pieces of information associated with the print job are limited upon transmission.

19. A program for making a computer execute the following step in a printing system for processing a print job transmitted from a terminal to a printer by the printer, said program comprising:
a control step of switching in accordance with a demanding party of the information associated with the print job whether all pieces of information associated with the print job are displayed on a display or some pieces of information associated with the print job are limited upon display on the display.

20. A program for making a computer execute the following step in an image forming apparatus for processing a print job received from a terminal, said program comprising:
a control step of switching in accordance with a demanding party of the information associated with the print job whether all pieces of information associated with the print job are displayed on a display or some pieces of information associated with the print job are limited upon display on the display.

21. A program for making a computer execute the following step in an image forming apparatus for processing a print job received from a terminal, said program comprising:
a transmission step of switching in accordance with a request from the terminal whether all pieces of information associated with the print job are transmitted or some pieces of information associated with the print job are limited upon transmission.
